(19) United States
(12) Patent Application Publication
(10) Pub. No.: US 2006/0062702 A1
(43) Pub. Date: Mar. 23, 2006

(54) Taylor reactor for substance tranformation

(75) Inventors: Edeltraud Hagemeister, Greven (DE); Werner-Alfons Jung, Ascheberg (DE); Heinz-Peter Rink, Munster (DE); Hans-Ulrich Moritz, Bendesdorf (DE); Iris Conrad, Ahrensburg (DE); Tsung-Chieh Cheng, Heppenheim (DE); Thomas Vens, Velen (DE)

Correspondence Address: BASF CORPORATION;ANNE GERRY SABOURIN, 26701 TELEGRAPH ROAD, SOUTHFIELD, MI, 48034-2442, US

(73) Assignee: BASF Coatings Aktiengesellschaft, 48165 Munster (DE)

(21) Appl. No.: 10/531,334

(22) PCT Filed: Sep. 16, 2003
(86) PCT No.: PCT/EP03/10278

§ 371 Date: Aug. 23, 2005

(30) Foreign Application Priority Data
Oct. 30, 2002 (DE) 102 50 420.2

(51) Int. Cl. C08F 2/00; B01J 19/00

(52) U.S. Cl. 422/131; 526/74

(57) ABSTRACT

In the Taylor reactor, in accordance with a first alternative of the invention, the reactor housing and/or the rotor are/is equipped such that the cross section of the reaction volume initially rises from the inlet to the outlet but the rise in cross section decreases in the direction of the outlet at least over part of the length of the rotor. In accordance with a second alternative of the invention, which may also find application in addition to the first, the end face of the rotor is designed in such a way that the reaction volume opens out into the outlet in such a way that it is at least substantially free from deadspaces (FIG. 4).

The present invention relates to a Taylor reactor for physical and/or chemical conversions in the course of which there is an increase in the viscosity of the reaction medium. Moreover, the present invention relates to a novel process for conversion by means of the Taylor reactor, and to the use of the substances prepared by the novel process.

Taylor reactors, which serve to convert substances under the conditions of Taylor vortex flow, have long been known. In their original embodiment they are composed of two coaxial concentric cylinders of which the outer is fixed while the inner rotates. The reaction space used is the volume formed between the inner periphery of the outer cylinder and the outer periphery of the inner cylinder. Increasing angular velocity of the inner cylinder is accompanied by a series of different flow patterns which are characterized by a dimensionless parameter, known as the Taylor number Ta. As well as on the angular velocity of the inner cylinder, which forms the rotor, the Taylor number is also dependent on the kinematic viscosity of the fluid in the reaction volume and on the geometric parameters, the external radius of the inner cylinder, rᵢ, and the internal radius of the outer cylinder, rₒ, in accordance with the following formula:
Ta=ωᵢ rᵢ d ν⁻¹(d/rᵢ)^{1/2} (I)
where d=rₒ−rᵢ.

At low angular velocity, the laminar Couette flow, a simple shear flow, is developed. If the rotary speed of the inner cylinder is increased further, then, above a critical level, alternately contrarotating vortices (rotating in opposition) occur, with axes along the peripheral direction. The vortices, called Taylor vortices, are rotationally symmetric, possess the geometric form of a torus (Taylor vortex ring), and have a diameter which is approximately the same size as the gap width. Two adjacent vortices form a vortex pair or vortex cell.

The basis of this behavior is the fact that, in the course of rotation of the inner cylinder with the outer cylinder at rest, the fluid particles near the inner cylinder are subject to a greater centrifugal force than those at a greater distance from the inner cylinder. This difference in the acting centrifugal forces displaces the fluid particles from the inner to the outer cylinder. The viscosity force acts counter to the centrifugal force, since for the fluid particles to move it is necessary for the friction to be overcome. Any increase in the rotary speed is accompanied by an increase in the centrifugal force. The Taylor vortices are formed when the centrifugal force exceeds the stabilizing viscosity force.

If the Taylor reactor is provided with an inlet and an outlet and is operated continuously, the result is a Taylor vortex flow with a low axial flow. Each vortex pair passes through the gap, with only a low level of mass transfer between adjacent vortex pairs. Mixing within such vortex pairs is very high, whereas axial mixing beyond the pair boundaries is very low. A vortex pair may therefore be regarded as a stirred tank in which there is thorough mixing. Consequently, the flow system behaves as an ideal flow tube in that the vortex pairs pass through the gap with a constant residence time, like ideal stirred-tanks.

If, however, as conversion progresses there is a sharp change in the viscosity ν of the fluid in the axial flow direction, as is the case with bulk polymerization, then the Taylor vortices disappear or are not even formed. In that case, Couette flow, a concentric, laminar flow, is observed in the annular gap and there is an unwanted change in the mixing and flow conditions within the Taylor reactor. In this operating state the reactor exhibits flow characteristics which are comparable with those of the laminarly flow-traversed tube, which is a considerable disadvantage. For example, during bulk polymerization there is an undesirably broad molar mass distribution and chemical nonuniformity of the polymers. Moreover, the adverse reaction regime may result in considerable quantities of residual monomers, which must then be discharged from the Taylor reactor. However, there may also be instances of coagulation and polymer deposition, which in some cases may even lead to blockage of the reactor or of the product outlet. All in all it is no longer possible to obtain the desired products, such as polymers having comparatively narrow molar mass distribution, for instance, the products which result instead being only those whose profile of properties fails to match the requirements.

DE 198 28 742 A1 discloses a Taylor reactor which in order to solve these problems has been given
a) an external reactor wall located within which there is a concentrically disposed rotor, a reactor floor, and a reactor lid, which together define the annular reaction volume,
b) at least one means for metered addition of reactants, and
c) a means for the discharge of product,
   where there is a widening, in particular a conical widening, in the annular reaction volume in the flow direction. As a result, the known Taylor reactor is able substantially to solve the problem of maintaining the Taylor flow when there is a sharp increase in the kinematic viscosity ν in the reaction medium.

In this known Taylor reactor, the annular reaction volume is defined by the concentrically disposed rotor, the reactor floor, and the reactor lid. This means that the product outlet has to be disposed on the side of the Taylor reactor or in the reactor lid, and cannot be designed without edges. With this configuration, however, it is difficult to realize undisrupted product discharge.

Owing to the deleterious interaction of flow and geometric configuration, on the one hand, the known Taylor reactor is still unable to solve all of the safety and engineering problems which occur in the course of bulk polymerization and, on the other hand, it is still not possible to increase the monomer conversion to an extent such that substantial freedom from monomers and a narrow molecular weight distribution and molecular weight polydispersity of the polymers are achieved.

Although the problem of inadequate mixing of the reactants can be solved to a certain extent by inserting a mixing unit upstream of the entry of the reactants, as is described in German patent application DE 199 60 389 A1, the problems outlined above which affect bulk polymerization still occur.

American patent U.S. Pat. No. 4,174,097 discloses a Taylor reactor in which the rotor is mounted rotatably in the inlet region for the reactants. At its other end, the rotor is not mounted but instead ends essentially before the outlet region, which at its widest point has the same diameter as the external reactor wall. The outlet region narrows in the manner of a funnel to form an outlet pipe. The known Taylor reactor serves for the mixing of liquids differing in viscosity and electrical conductivity. It may also serve for reaction of polyisocyanates with polyols. To what extent it may be used for the bulk polymerization of olefinically unsaturated monomers, the American patent does not reveal.

In the case of the known Taylor reactor, the driveshaft is guided through the reactor floor and is connected to the rotor in the inlet region of the reactants. However, there is no widening in the annular reaction volume in the flow direction. Although the American patent specifies, in column 10 lines 29 to 33, that the concentric parts may also have configurations other than the cylindrical—for example, substantially spherical or conical configurations—there is no teaching as to which configurations are especially advantageous for bulk polymerization.

Despite the fact that, with the Taylor reactors having a reaction volume widening in the flow direction, it was possible to increase the monomeric conversions and to reduce the formation of gel particles, the polydispersities found for the preparation of polyacrylate resins were >3. Conversions >99% were realizable only when a certain amount of acrylate monomer was present.

It is an object of the present invention, accordingly, to reduce the polydispersities while at the same time raising the conversion rate.

This object is achieved by the Taylor reactors reproduced in the independent claims 1, 10 and 13. References below to a “Taylor reactor” are intended to express the fact that, viewed in the direction of the axis of rotation of the rotor, in other words in the flow direction of the reaction medium, Taylor vortices are formed at least over one subregion of the reaction volume while the reactor is in operation.

Surprisingly it has been found that, with a Taylor reactor in which the reactor housing and/or the rotor are configured such that the cross section of the reaction volume rises, at least to start with, from the inlet to the outlet but in the direction of the outlet—that is, in the flow direction of the reaction medium—there is a decrease in the rise, at least over part of the length of the rotor, it is possible to achieve a marked reduction in the polydispersities. One possible explanation for this effect is the reduction or even prevention of short-circuit flows at the edges delimiting the reaction volume, which may form if the Taylor vortices do not extend up to the edges. By “short-circuit flow”, therefore, is meant a flow within the reactor in the flow direction of the reaction media, which partially circumvents the mixing operation and so reduces the residence time in the reactor, leading to lower degrees of polymerization.

Experiments have shown that the Taylor reactor of the invention is, surprisingly, suitable for all conversions where there was a sharp change in the kinematic viscosity ν of the reaction medium in the flow direction.

Particularly surprising is that the Taylor reactor of the invention and the process of the invention allow the free-radical, anionic, and cationic (co)polymerization, graft copolymerization, and block copolymerization (referred to collectively as “polymerization”) of olefinically unsaturated monomers in bulk with conversion rates >70 mol %. Even more surprising is that conversion rates >98 mol % can be obtained without problems in the Taylor reactor of the invention without the formation of disruptive gas bubbles and/or the deposition of (co)polymers, graft copolymers, and block copolymers (referred to collectively as “polymers”).

A further surprise is that the Taylor reactor of the invention and the process of the invention allow a particularly safe bulk polymerization reaction regime, allowing the polymers to be produced very safely, reliably, and reproducibly. Owing to the very low levels of monomer in the polymers, they can be put to a very wide variety of end uses without additional purification and without the occurrence of safety, engineering, toxicological or environmental problems or odor nuisance.

The Taylor reactor of the invention preferably comprises an annular reaction volume which preferably has a circular periphery. The annular reaction volume is defined or formed by an outer reactor wall located within which there is a concentrically disposed rotor which is disposed so as to be rotatable around the axis of rotation.

Over the entire length of the reaction volume, as viewed in cross section, the external reactor wall and the rotor have a circular periphery. The term “circular” means strictly circular, oval, elliptical or polygonal with rounded angles. For reasons of greater ease of manufacture, simplicity of construction and significantly greater ease of maintaining constant conditions over the entire length of the annular reaction volume, a strictly circular periphery is of advantage.

The internal wall of the external reactor wall and/or the surface of the rotor may be smooth or rough, i.e., the surfaces in question may have a low or high roughness. Additionally or alternatively, the internal wall of the external reactor wall and/or the surface of the rotor may have a relieflike radial and/or axial, preferably radial, surface profile, as described, for example, in American patent U.S. Pat. No. 4,174,90 A or British patent GB 1 358 157. If there is a radial surface profile, it is advantageously of approximately or exactly the same dimensions as the Taylor vortex rings.

It is of advantage, however, for the internal wall of the external reactor wall and the surface of the rotor to be smooth and unprofiled, in order to prevent dead corners into which gas bubbles or reactants, process media, and products might settle.

Viewed in the lengthwise direction, the Taylor reactor of the invention is mounted vertically, horizontally or in a position between these two directions. Vertical mounting is advantageous. If the Taylor reactor of the invention is not mounted horizontally, it may be traversed by the reaction medium flowing against gravity, from bottom to top, or with gravity, from top to bottom. In accordance with the invention it is advantageous if the reaction medium is moved counter to gravity.

By influencing the rate at which the reaction medium passes through the reactor, by varying the feed rate at the inlet, it is possible to influence the course of viscosity in the reaction medium. The reactor can therefore be used for various reaction mixtures.

In accordance with the invention, the rise in the cross section of the reaction volume in the flow direction decreases continuously or discontinuously, especially continuously, in accordance with appropriate mathematical functions. Examples of appropriate mathematical functions are straight lines, at least two straight lines which intersect one another at an obtuse angle, parabolas, hyperbolas, e functions or combinations of these functions with continuous or discontinuous transitions, especially continuous transitions, between them. The mathematical functions are preferably straight lines; in other words, the preferably annular cross section of the reaction volume in the flow direction widens constantly in a first section at a greater rate than in a second section, in which the cross section widens to a lesser extent, and is preferably constant. The extent of the widening is guided by the anticipated increase in the viscosity of the reaction medium in the flow direction and can be estimated by the skilled worker on the basis of the Taylor formula I and/or determined by the skilled worker on the basis of simple preliminary experiments.

In the context of the widening of the cross section of the annular reaction volume, the external reactor wall may be cylindrical and the rotor conical in shape, with the rotor having the greatest diameter on the inlet side. Alternatively, the external reactor wall may be conical in shape and the rotor cylindrical, i.e., with its cross section constant over the entire length of the rotor. In accordance with the invention it is advantageous if the external reactor wall is conical in a first, inlet-side region and cylindrical in a second region, and the rotor is cylindrical.

If the outlet is disposed axially, i.e., if it opens out into the reaction volume in the direction of the rotational axis of the rotor, the supply of the reactants and/or of the process media brings about flow in the reaction volume in the direction of the outlet and through the outlet.

In the case of a further constructional design of a Taylor reactor, the flow about the rotational axis is also utilized as a driving force for the removal of the reaction products, in that the outlet opens out into the reaction volume radially at a distance from the rotational axis.

The angle of opening out between the rotational axis and the outlet line defined by the outlet is arbitrary. It is preferred, however, if outlet line and rotational axis form an angle of between 0° and 90°, i.e., if the outlet opens out into the reaction volume transversely with respect to the rotational axis.

Particularly when the outlet extends approximately perpendicular to the rotational axis in the region of opening out, the component of the flow around the rotational axis, as a fraction of the driving force for the removal of the reaction products, reaches its maximum. In this case it is advantageous to design the end adjacent to the outlet in the manner of a pump rotor, in order to generate as great as possible a flow about the rotational axis in this region.

This can be done without adverse consequences for the reaction procedure within the reactor, since owing to the high viscosity and the fact that a conversion rate of approximately 99% has already been achieved there is no longer any need for Taylor vortices or reaction procedures.

In the narrowest region of the annular reaction volume, located above the reactor floor, there is at least one inlet for the reactants, especially for the olefinically unsaturated monomers, and for suitable process media, such as catalysts and initiators. The inlet may be disposed laterally or may pass through the reactor floor. Preferably there are at least two inlets, which are disposed laterally and/or pass through the reactor floor. Where appropriate, it is possible in the flow direction to provide further inlets, through which further reactants, catalysts or initiators can be metered in, so that the conversions, particularly the polymerization, may be conducted in a plurality of stages.

The reactants can be supplied to the inlet by means of conventional techniques and means, such as metering pumps. The means may be equipped with conventional mechanical, hydraulic, optical, and electronic measurement and control devices. Additionally, it is possible to insert, upstream of the inlet, one of the mixing means described, for example, in German patent application DE 199 60 389 A1, column 4 line 55 to column 5 line 34.

In the case of the inventive Taylor reactor as claimed in claim 10, there is an outlet region which tapers in the flow direction toward a product outlet.

The end face of the rotor, i.e., the end facing the outlet, is designed so that the reaction volume opens out into the product outlet with at least substantially no dead spaces.

The outlet region and the product outlet are defined by the external reactor wall.

The tapering of the outlet region may be described by the mathematical functions set out above, preference being given to straight lines. Accordingly, the tapering of the outlet region is preferably conical. In that case the end face of the rotor is preferably of conical design, in order—as is preferred—to ensure that the cross section of the outlet region is substantially constant in the direction of the axis. The result of this is to prevent dead spaces, while at the same time not giving rise to any adverse pressure buildup.

The reactor wall in the inlet region, in the region of the annular reaction volume, and in the outlet region, and also the inlet or inlets and the product outlet, may be equipped with a heating or cooling jacket, allowing heating or cooling to be carried out in cocurrent or in countercurrent. Moreover, the Taylor reactor of the invention may contain conventional mechanical, hydraulic, optical, and electronic measurement and control means, such as temperature sensors, pressure meters, flow meters, optical or electronic sensors, and devices for measuring concentrations, viscosities, and other physicochemical variables, these devices passing on their measured data to a data processing unit, which controls the entire process sequence.

The Taylor reactor of the invention is preferably of pressuretight design, so that the reaction medium may stand preferably under a pressure of from 1 to 100 bar. The Taylor reactor of the invention may be made of any of a wide variety of materials, provided they are not attacked by the reactants or reaction products and they withstand a relatively high pressure. It is preferred to use metals, preferably steel, particularly stainless steel.

The Taylor reactor of the invention can be put to a very wide variety of end uses. It is preferably used for conversions in the course of which there is a rise in the kinematic viscosity ν of the reaction medium in the flow direction.

Examples of conversions which can be carried out in the Taylor reactor of the invention with particular advantages are the synthesis or degradation of oligomeric and high molecular mass substances, such as the polymerization of monomers in bulk, solution, emulsion or suspension, or by precipitation polymerization.

Further examples of such conversions are
polymer-analogous reactions, such as the esterification, amidation or urethanization of polymers containing side groups suitable for such reactions,
the preparation of olefinically unsaturated materials curable using electron beams or ultraviolet light,
the preparation of polyurethane resins and modified polyurethane resins such as acrylated polyurethanes,
the preparation of (poly)ureas or modified (poly)ureas,
the molecular weight buildup of compounds terminated by isocyanate groups,
or reactions which lead to the formation of mesophases, as described, for example, by Antonietti and Göltner in the article “Überstruktur funktionneller Kolloide: eine Chemie im Nanometerbereich” [Superstructure of functional colloids: a chemistry in the nanometer range] in Angewandte Chemie 109 (1997) 944 to 964, or by Ober and Wengner in the article “Polyelectrolyte-Surfactant Complexes in the Solid State: Facile Building Blocks for Self-Organizing Materials” in Advanced Materials 9 (1997) 1, 17 to 31.

With very particular advantage, the process of the invention is employed for the polymerization of olefinically unsaturated monomers in bulk, since in that case the particular advantages of the Taylor reactor of the invention are manifested with particular clarity.

Accordingly, the Taylor reactor of the invention is used with particular preference for preparing polymers and copolymers of chemically uniform composition. In the case of copolymerization, the more rapidly polymerizing comonomer or comonomers can be metered in by way of inlets disposed in succession in the axial direction, so that the comonomer ratio can be kept constant over the entire length of the reactor.

The Taylor reactor is also used with particular advantage for graft copolymerization.

In this case, the backbone polymer, as it is known, can be prepared separately and introduced into the Taylor reactor of the invention by way of a separate inlet or in a mixture with at least one monomer.

Alternatively, the backbone polymer can be prepared in a first subsection of the Taylor reactor of the invention, after which at least one monomer which forms the graft branches is metered in by way of at least one further inlet, offset in the axial direction. Subsequently, the monomer or comonomers can be grafted onto the backbone polymer in at least one further subsection of the Taylor reactor of the invention. Where two or more comonomers are used, they may be metered in individually by way of one inlet in each case or as a mixture, through one inlet or two or more inlets. Where at least two comonomers are metered in individually and in succession through at least two inlets, it is even possible to prepare graft branches which viewed per se are block copolymers, in a particularly simple and elegant manner.

Naturally, this concept as described above may also be used to prepare block copolymers per se.

Analogously, the Taylor reactor of the invention can be used to effectuate the preparation of core/shell lattices in a particularly simple and elegant manner. Initially, in the first subsection of the Taylor reactor of the invention, the core is prepared by polymerizing at least one monomer. By way of at least one further inlet, at least one further comonomer is metered in and the shell is polymerized onto the core in at least one further subsection. In this way it is possible to apply a plurality of shells to the core.

The preparation of polymer dispersions may also be effected by means of the Taylor reactor of the invention. For example, at least one monomer in a homogeneous phase, particularly in solution, is (co)polymerized in a first subsection of the Taylor reactor of the invention, after which a precipitant is metered in by way of at least one further means, resulting in the polymer dispersion.

For all applications, the Taylor reactor of the invention has the particular advantage of a large specific cooling area, which allows a particularly safe reaction regime.

With very particular preference, the Taylor reactor of the invention is used for the continuous preparation of (co)polymers, block copolymers, and graft copolymers by free-radical, anionic or cationic, especially free-radical, (co)polymerization, block copolymerization or graft copolymerization (polymerization) of at least one olefinically unsaturated monomer in bulk by the process of the invention.

Examples of monomers suitable for the process of the invention are acyclic and cyclic, unfunctionalized and functionalized monoolefins and diolefins, vinylaromatic compounds, vinyl ethers, vinyl esters, vinyl amides, vinyl halides, allyl ethers, and allyl esters, acrylic acid and methacrylic acid and their esters, amides, and nitrites, and maleic acid, fumaric acid, and itaconic acid and their esters, amides, imides, and anhydrides.

Examples of suitable monoolefins are ethylene, propylene, 1-butene, 1-pentene, 1-hexene, 1-heptene, 1-octene, cyclobutene, cyclopentene, dicyclopentene, and cyclohexene.

Examples of suitable diolefins are butadiene, isoprene, cyclopentadiene, and cyclohexadiene.

Examples of suitable vinylaromatic compounds are styrene, alpha-methylstyrene, 2-, 3-, and 4-chloro-, -methyl-, -ethyl-, -propyl-, and -butyl- and -tert-butylstyrene and -alpha-methylstyrene.

One example of a suitable vinyl compound or of a functionalized olefin is vinylcyclohexanediol.

Examples of suitable vinyl ethers are methyl, ethyl, propyl, butyl, and pentyl vinyl ether, allyl monopropoxylate, and trimethylolpropane monoallyl, diallyl, and triallyl ether.

Examples of suitable vinyl esters are vinyl acetate and vinyl propionate and also the vinyl esters of Versatic acid and other quaternary acids.

Examples of suitable vinyl amides are N-methyl-, N,N-dimethyl-, N-ethyl-, N-propyl-, N-butyl-, N-amyl-, N-cyclopentyl-, and N-cyclohexylvinylamide and also N-vinylpyrrolidone and N-epsilon-caprolactam.

Examples of suitable vinyl halides are vinyl fluoride and vinyl chloride.

Examples of suitable vinylidene halides are vinylidene fluoride and vinylidene chloride.

Examples of suitable allyl ethers are methyl, ethyl, propyl, butyl, pentyl, phenyl, and glycidyl monoallyl ether.

Examples of suitable allyl esters are allyl acetate and allyl propionate.

Examples of suitable esters of acrylic acid and methacrylic acid are methyl, ethyl, propyl, n-butyl, isobutyl, n-pentyl, n-hexyl, 2-ethylhexyl, isodecyl, decyl, cyclohexyl, t-butylcyclohexyl, norbornyl, isobornyl, 2- and 3-hydroxypropyl, 4-hydroxybutyl, trimethylolpropane mono- pentaerythritol mono-, and glycidyl (meth)acrylate. Also suitable are the di-, tri-, and tetra(meth)acrylates of ethylene glycol, di-, tri-, and tetraethylene glycol, propylene glycol, dipropylene glycol, butylene glycol, dibutylene glycol, glycerol, trimethylolpropane, and pentaerythritol. However, they are used not alone but always in minor amounts together with the monofunctional monomers.

Examples of suitable amides of acrylic acid and methacrylic acid are (meth)acrylamide and also N-methyl-, N,N-dimethyl-, N-ethyl-, N-propyl-, N-butyl-, N-amyl-, N-cyclopentyl-, and N-cyclohexyl(meth)acrylamide.

Examples of suitable nitriles are acrylonitrile and methacrylonitrile.

Examples of suitable esters, amides, imides, and anhydrides of maleic, fumaric, and itaconic acids are dimethyl, diethyl, dipropyl, and dibutyl maleate, fumarate, and itaconate, maleamide, fumaramide, and itaconamide, N,N′-dimethyl-, N,N,N′,N′-tetramethyl-, N,N′-diethyl-, N,N′-dipropyl-, N,N′-dibutyl-, N,N′-diamyl, N,N′-dicyclopentyl and N,N′-dicyclohexyl-maleamide, fumaramide, and itaconamide, maleimide, fumarimide, and itaconimide, and N-methyl-, N-ethyl-, N-propyl-, N-butyl-, N-amyl-, N-cyclopentyl-, and N-cyclohexyl-maleimide, -fumarimide, and -itaconimide, and also maleic anhydride, fumaric anhydride, and itaconic anhydride.

The monomers described above may be polymerized free-radically, cationically or anionically. Advantageously they are polymerized free-radically. For this purpose it is possible to use the conventional inorganic free-radical initiators such as hydrogen peroxide or potassium peroxodisulfate or the conventional organic free-radical initiators such as dialkyl peroxides, e.g., di-tert-butyl peroxide, di-tert-amyl peroxide, and dicumyl peroxide; hydroperoxides, e.g., cumene hydroperoxide and tert-butyl hydroperoxide; peresters, e.g., tert-butyl perbenzoate, tert-butyl perpivalate, tert-butyl per-3,5,5-trimethylhexanoate, and tert-butyl per-2-ethylhexanoate; disazo compounds such as azobisisobutyronitrile; or C-C initiators such as 2,3-dimethyl-2,3-diphenyl-butane or -hexane. Also suitable, however, is styrene, which initiates polymerization thermally even without free-radical initiators.

In the process of the invention, at least one of the above-described monomers is metered via a lateral inlet into the inlet region of the Taylor reactor of the invention. It is preferred to meter at least one of the above-described free-radical initiators, preferably together with at least one monomer, via a further lateral inlet.

The monomer or monomers is or are polymerized within the reaction volume at least partly under the conditions of Taylor flow. The resultant liquid polymer is conveyed from the annular reaction volume into the outlet region and from there into the product outlet, and is discharged by way of the pressure maintenance valve.

Preferably, in the process of the invention, the conditions for Taylor flow are met in part of the annular reaction volume or in the entire annular reaction volume, especially in the entire annular reaction volume.

The temperature of the reaction medium in the process of the invention may vary widely and is guided in particular by the monomer having the lowest decomposition temperature, by the temperature at which depolymerization sets in, and by the reactivity of the monomer or monomers and of the initiators. Preferably the polymerization is conducted at temperatures from 100 to 200° C., more preferably from 130 to 180° C., and in particular from 150 to 180° C.

The polymerization may be carried out under pressure. The pressure is preferably from 1 to 100 bar, more preferably from 1 to 25 bar, and in particular from 1 to 15 bar.

The traversal time may vary widely and depends in particular on the reactivity of the monomers and on the size, especially the length, of the Taylor reactor of the invention. The traversal time is preferably from 15 minutes to 2 hours, in particular from 20 minutes to 1 hour.

It is a very particular advantage of the Taylor reactor of the invention and of the process of the invention that the conversion of the monomers is >70 mol %.

Surprisingly it is possible without problems to achieve conversions >80, preferably >90, with particular preference >95, with very particular preference >98, and in particular >98.5 mol %. As is customary in the case of bulk polymerization, it is possible in the course of such conversions for the kinematic viscosity ν to increase by a factor of at least ten, in particular at least one hundred.

The molecular weight of the polymers prepared by means of the process of the invention may vary widely and is limited essentially only by the maximum kinematic viscosity ν at which the Taylor reactor of the invention is able to maintain the conditions of Taylor flow. The number average molecular weights of the polymers prepared in an inventive procedure are preferably from 800 to 50,000, more preferably from 1,000 to 25,000, and in particular from 1,000 to 10,000 daltons. The molecular weight polydispersity is preferably <10, in particular <8.

The drawings show exemplary embodiments of the invention; specifically

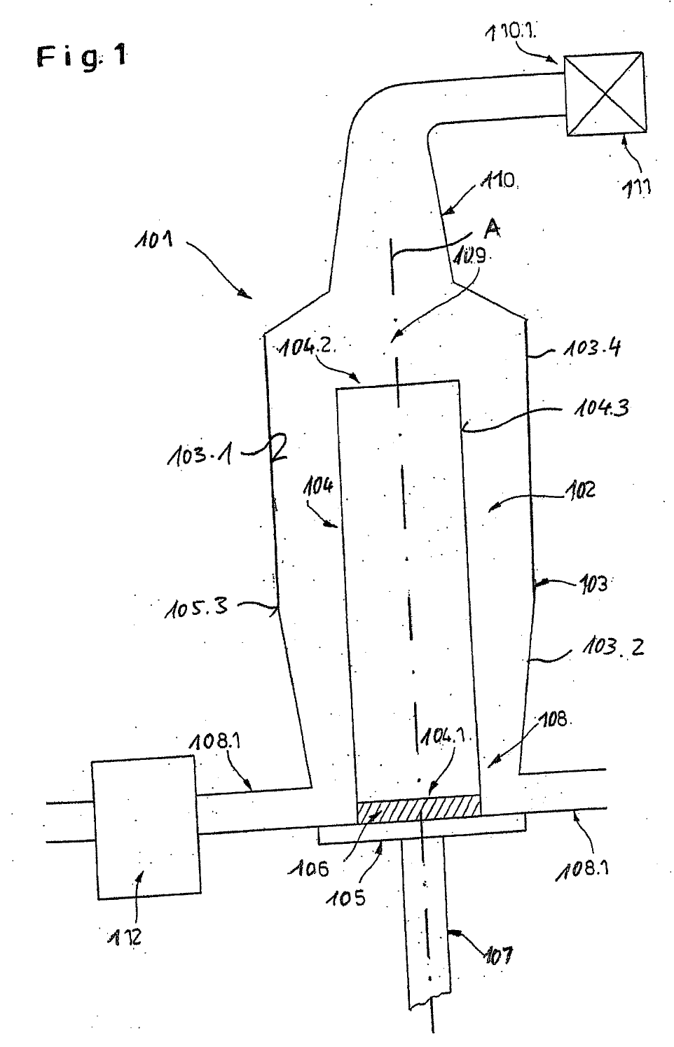

FIG. 1 shows—diagrammatically—an exemplary embodiment of a Taylor reactor of the invention in accordance with the first alternative of the invention, in longitudinal section;

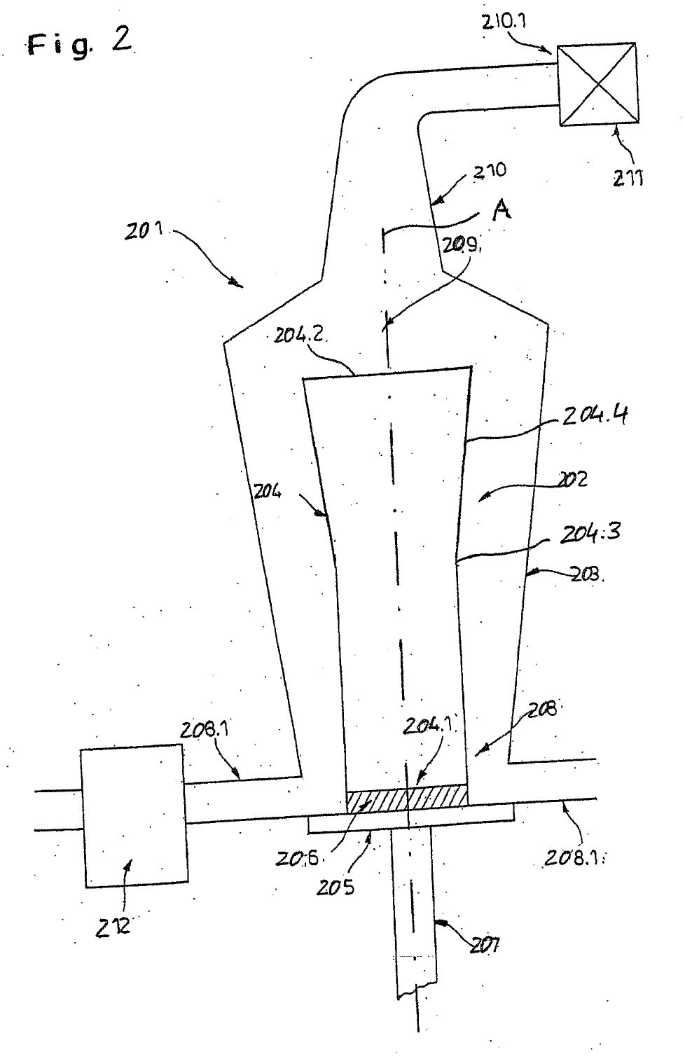

FIG. 2 shows a further exemplary embodiment of a Taylor reactor of the invention in accordance with the first alternative of the invention, in a representation corresponding to that of FIG. 1;

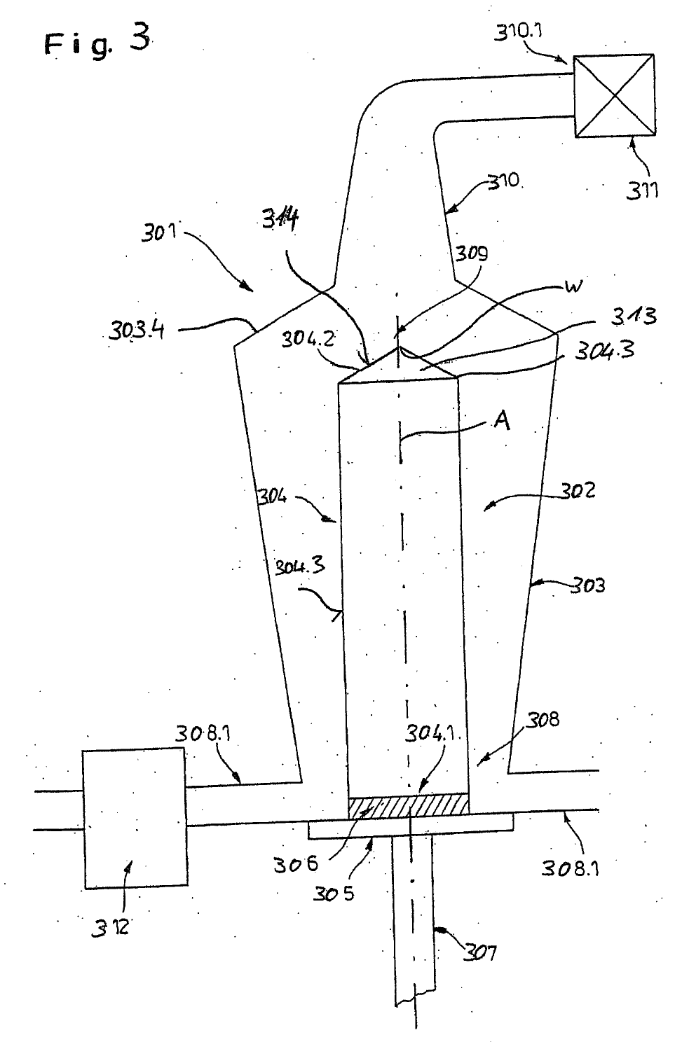

FIG. 3 shows an exemplary embodiment of a Taylor reactor of the invention in accordance with the second alternative of the invention, in a view corresponding to that of FIG. 1;

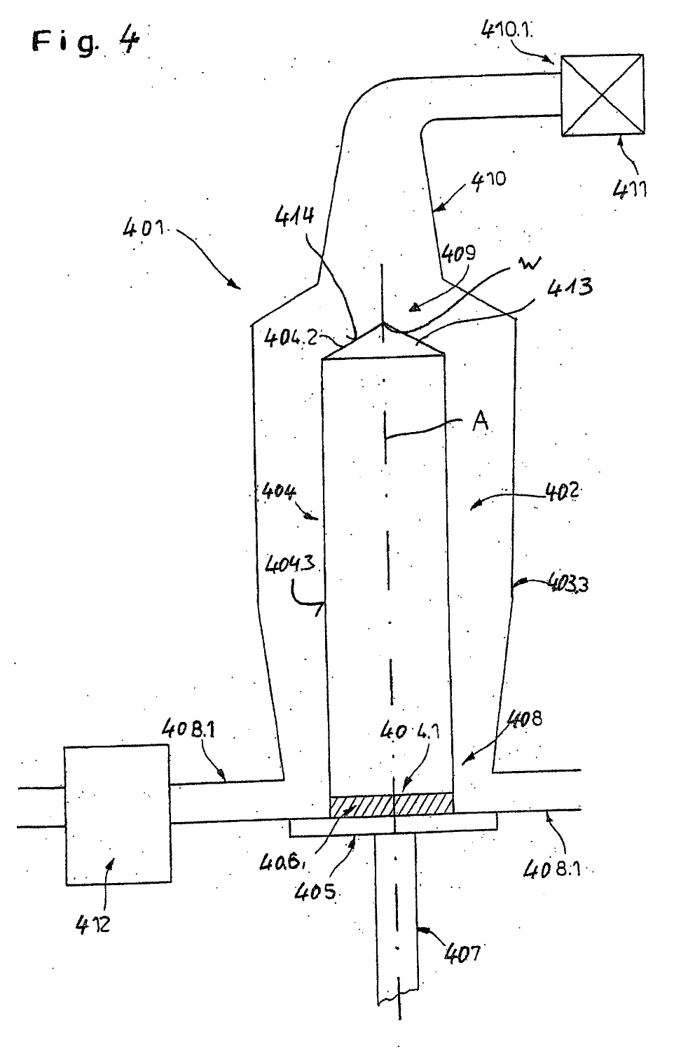

FIG. 4 shows an exemplary embodiment of a Taylor reactor of the invention, in which both alternatives of the invention are realized, in a view corresponding to that of FIGS. 1 and 2;

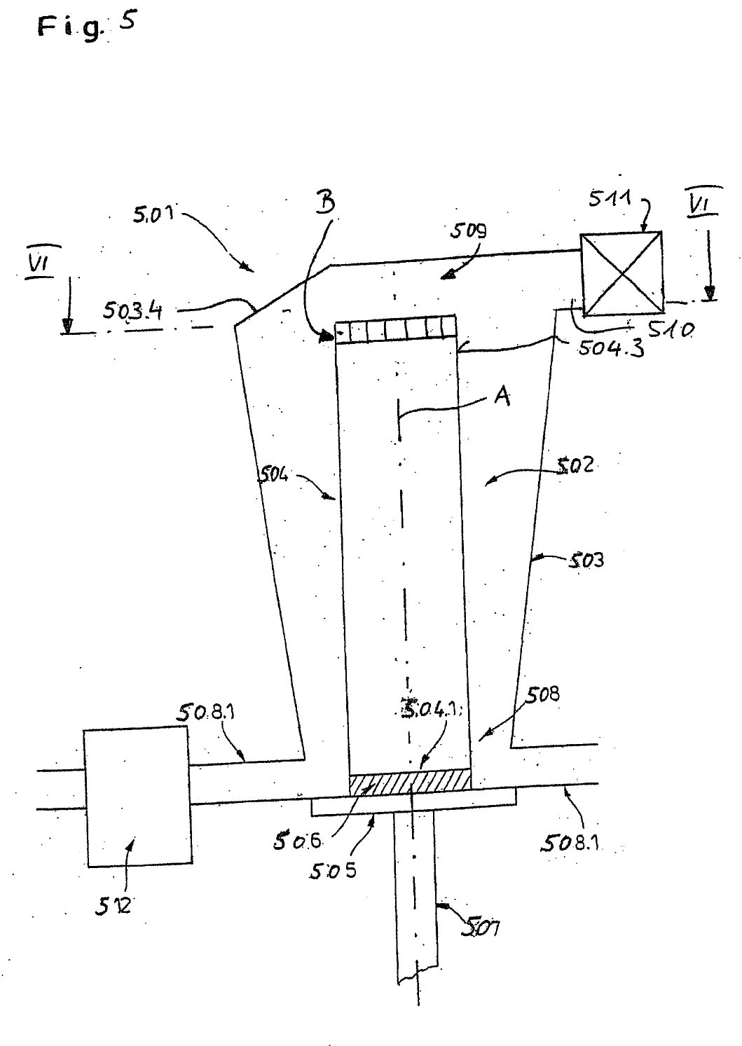

FIG. 5 shows an exemplary embodiment of a Taylor reactor of the invention in accordance with the third alternative of the invention, in a view corresponding to that of FIG. 1; and

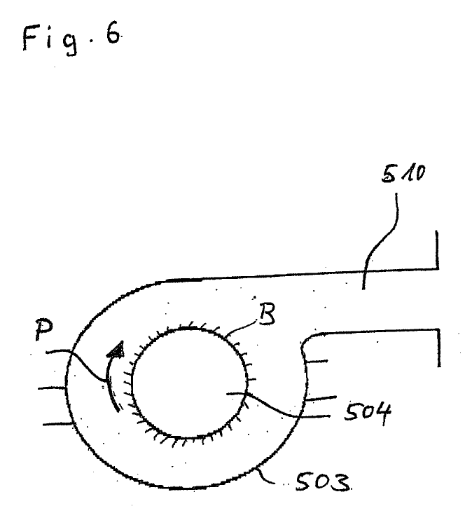

FIG. 6 shows a section along the line VI-VI in FIG. 5.

The Taylor reactor which as a whole is designated by 100 in FIG. 1 comprises a reactor housing 103 whose lower region—lower, that is, in accordance with the representation in FIG. 1, which corresponds to the normal operating position of the Taylor reactor 100—is designed as an insertion region 108. Opening out into said region 108 are two inlets 108.1, which are opposite one another laterally and through which it is possible to supply the reactants and/or process media to the reaction volume 102, which is formed between the outer periphery 104.3 of a cylindrical rotor 104 and the inner periphery 103.1 of the reactor housing 103.

The section 103.2 of the reactor housing 103 that adjoins the inlet region 108 is configured so as to widen conically upward until it reaches the point 103.3, so that the cross section of the reaction volume 102 rises in the section 103.2. Moving upward, the point 103.3 is followed by a cylindrical section 103.4 of the reactor housing 103, which extends to beyond the upper end face 104.2 of the rotor 104. Following the cylindrical section 103.4 is an outlet region 109 which runs together in the shape of a funnel and which opens out into an outlet 110, which is used to discharge the reaction products. Downstream of the outlet 110 is a pressure maintenance valve 111 which can be used to maintain the reaction media under a predeterminable pressure within the reaction volume.

The rotor 104 is mounted on the inlet-side end wall 105, shown at the bottom in FIG. 1 so as to be rotatable around an axis A. Introduction of a torque which brings about rotation in the rotor 104 is effected by a driveshaft 107, which is passed through the end wall 105 and is connected with a rotary drive—an electric motor, for example—which is not shown in the drawing. The sealing of the reaction volume 102 in the region where the driveshaft 107 passes through the end wall 105 is effected by a gasket 106, which is arranged between the end wall 105 and the end 104.1 of the rotor 104, which is shown at the bottom in the drawing.

For the purpose of premixing the reactants and/or process media which are supplied to the reaction volume, it is possible for one or more inlets to be equipped with mixers 112.

As apparent from FIG. 1, the design of the reactor housing 103 and of the rotor 104 has the effect that the cross section of the reaction volume, as viewed from inlet to outlet, initially rises in section 103.2 of the reactor housing but from the point 103.3 the rise decreases—in the exemplary embodiment depicted, to a value of 0—to the outlet in the cylindrical housing section 103.4.

The exemplary embodiment depicted in FIG. 2 agrees in large part with that of FIG. 1 in terms of its technical configuration. In order to save repetition, only the differences will be illustrated below. Components corresponding to the exemplary embodiment of FIG. 1 have been given reference numerals increased by 100.

In the case of the exemplary embodiment depicted in FIG. 2, the reactor housing 203 is designed with a conical widening up to the outlet region 209. In order to bring about the inventive decrease in the rise of the cross section of the reaction volume of the outlet, the rotor 204, which is designed cylindrically in its region which is at the bottom in accordance with FIG. 2, has a point 204.3 starting from which it undergoes transition to the region 204.4, which widens conically to the outlet region 209. The conicity corresponds to that of the reactor housing 203, so that the cross section of the reaction volume from point 204 to the top end of the rotor remains constant.

In the case of the Taylor reactor which is designated as a whole by 301 and is depicted in FIG. 3, and which is an exemplary embodiment in accordance with the second alternative of the invention, again only the differences from the Taylor reactor according to FIG. 1 will be addressed. Reference is again made to the description relating to FIG. 1, the corresponding components in FIG. 3 having been given reference symbols increased by 200.

The reactor housing 303 of the Taylor reactor 301 is designed so as to widen conically from the inlet region 308 to the outlet region 309. The rotor 304 has a cylindrical design, which at the point 304.3 undergoes transition to a cone 313. The cone angle d is chosen so that the cone surface 314 runs parallel to the wall 303.4 of the reactor housing 303, said wall delimiting the outlet region 309. By this means, the reaction volume opens out into the outlet 310 in a way which is at least substantially deadspace-free. This effectively prevents parts of the reaction medium being deposited above the rotor 304, which would lead to unwanted, further polymerization by prolonging the residence time in the reactor.

FIG. 4 shows one particularly preferred exemplary embodiment of a Taylor reactor of the invention, in which both alternatives of the invention have been realized. The Taylor reactor, now designated 401, comprises a reactor housing 403 which corresponds to that depicted in FIG. 1. The rotor 404, like that in FIG. 3, has been provided at its top end with a cone 413.

In this particularly preferred embodiment, therefore, both short circuit flows in the reaction volume 402 and the formation of deadspaces in the outlet region 409 are prevented.

1. A Taylor reactor (101, 201, 301, 401)
comprising a reactor housing (103, 203, 303, 403),
having a rotor (104, 204, 304, 404) which is disposed in the volume enclosed by the reactor housing (103, 203, 303, 403) and is rotatable about an axis,
having a reaction volume (102, 202, 302, 402) formed between the inner periphery of the reactor housing (103, 203, 303, 403) and the outer periphery (104.3, 204.3, 304.3, 404.3) of the rotor (104, 204, 304, 404),
having at least one inlet (108.1, 208.1, 308.1, 408.1) for the reactants and/or process media and having at least one outlet (110, 210, 310, 410) for the reaction products, disposed in the direction of the axis (A) at a distance from the inlet (108.1, 208.1, 308.1, 408.1), wherein the reactor housing (103, 203, 303, 403) and/or the rotor (104, 204, 304, 404) are equipped such that the cross section of the reaction volume (102, 202, 302, 402) initially rises from the inlet (108.1, 208.1, 308.1, 408.1) to the outlet (110, 210, 310, 410) but the rise in cross section does not increase at least over part of the length of the rotor (104, 204, 304, 404).

2. A Taylor reactor as claimed in claim 1, wherein the rotor (104, 204, 304, 404) is disposed concentrically in the reactor housing (103, 203, 303, 403).

3. A Taylor reactor as claimed in claim 1, wherein the reaction volume (102, 202, 302, 402) is of annular design.

4. A Taylor reactor as claimed in claim 3, wherein the reaction volume (102, 202, 302, 402) has a circular periphery.

5. A Taylor reactor as claimed in claim 1, wherein the decrease in the rise of the cross section of the reaction volume (102, 202, 302, 402) is continuous.

6. A Taylor reactor as claimed in claim 1, wherein the decrease in the rise of the cross section of the reaction volume (102, 202, 302, 402) is discontinuous.

7. A Taylor reactor as claimed in claim 6, wherein at least one of the reactor housing (103, 203, 303, 403) or the rotor (104, 204, 304, 404) have, in the direction of the axis (A), at least two sections whose inner periphery and/or outer periphery form(s) different angles with respect to the axis (A).

8. A Taylor reactor as claimed in claim 1, wherein the ratio of the radius of the reactor housing (rₒ) to the radius of the rotor (rᵢ) at least for part of the length of the reaction volume (102, 202, 302, 402) is <1.4.

9. A Taylor reactor as claimed in claim 1, wherein the rotor (104, 204, 304, 404) is cylindrical.

10. A Taylor reactor having a reactor housing (103, 203, 303, 403), having a rotor (104, 204, 304, 404) which is disposed in the volume enclosed by the reactor housing (103, 203, 303, 403) in such a way as to be rotatable about an axis (A), having a reaction volume (102, 202, 302, 402) formed between the inner periphery (103.1, 203.1, 303.1, 403.1) of the reactor housing (103, 203, 303, 403) and the outer periphery (104.3, 204.3, 304.3, 404.3) of the rotor (104, 204, 304, 404), having at least one inlet (108.1, 208.1, 308.1, 408.1) for the reactants and/or process media, in particular as claimed in claim 1, wherein an outlet region (109, 209, 309, 409) which opens out into an outlet (110, 210, 310, 410) is provided which in the reactor housing (103, 203, 303, 403) at one end face of the rotor (104, 204, 304, 404) adjoins the reaction volume (102, 202, 302, 402) and narrows to an outlet (110, 210, 310, 410) and wherein the end face of the rotor (104, 204, 304, 404) is designed such that the reaction volume (102, 202, 302, 402) opens out at least essentially without deadspaces into the outlet (110, 210, 310, 410).

11. A Taylor reactor as claimed in claim 10, wherein the end face of the rotor (104, 204, 304, 404) is designed such that in the direction of the axis (A) the cross section of the outlet region (109, 209, 309, 409) is at least substantially constant.

12. A Taylor reactor as claimed in claim 10 or 11, wherein the reactor housing (103, 203, 303, 403) is configured such that the outlet region (109, 209, 309, 409) is in the shape of a funnel and the end face of the rotor (104, 204, 304, 404) is of conical design.

13. A Taylor reactor
having a reactor housing (503),
having a rotor (504) which is disposed in the volume enclosed by the reactor housing (503) in such a way as to be rotatable about an axis (A),
having a reaction volume (502) formed between the inner periphery (503.1) of the reactor housing (503) and the outer periphery (504.3) of the rotor (504), having at least one inlet (508.1) for the reactants and/or process media and having at least one outlet (510) for the reaction products, in particular as claimed in claim 1, wherein the outlet (510) opens out into the reaction volume (502) at a radial distance from the axis (A).

14. A Taylor reactor as claimed in claim 13, wherein the outlet (510) opens out transversely, preferably perpendicularly, to the axis (A) into the reaction volume (502).

15. A Taylor reactor as claimed in claim 13 or 14, wherein the region (B) of the rotor (504) that is adjacent to the outlet (510) comprises means for generating a circulation flow around the axis (A).

16. A Taylor reactor as claimed in claim 15, wherein the region (B) of the rotor (504) that is adjacent to the outlet (510) is designed in the manner of a centrifugal pump rotor.

17. A process for converting substances, where the kinematic viscosity ν of the reaction medium increases in the flow direction of the reactor, which comprises using therefor a Taylor reactor as claimed in claim 1.

18. A process as claimed in claim 17 for preparing sustances selected from the group consisting of polymers, copolymers, block polymers, graft copolymers, polycondensates, polyadducts, core/shell lattices, polymer dispersions, products of polymer-analogous reaction, including esterification, amidation and urethanization of polymers containing side groups suitable for such reactions, olefinically unsaturated materials curable with electron beams or ultraviolet light, or mesophases.

19. Substances prepared by the process of claim 17 comprising components of at least one of moldings, films, coating materials, paints, adhesives, or sealants.
